(19) United States
(12) Patent Application Publication
(10) Pub. No.: US 2026/0111137 A1
(43) Pub. Date: Apr. 23, 2026

(54) Method and Apparatus of Migrating Memory Data, and Non-Volatile Readable Storage Medium and Electronic Apparatus

(71) Applicant: SUZHOU METABRAIN INTELLIGENT TECHNOLOGY CO., LTD., Suzhou, Jiangsu (CN)

(72) Inventors: Yun WANG, Suzhou, Jiangsu (CN); Xinglong WANG, Suzhou, Jiangsu (CN); Jinfeng LI, Suzhou, Jiangsu (CN); Haimeng WANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/137,733

(22) PCT Filed: Jan. 4, 2024
(86) PCT No.: PCT/CN2024/070674

§ 371 Date: Nov. 13, 2025

(30) Foreign Application Priority Data
Jun. 21, 2023 (CN) 202310743575.1

(51) Int. Cl. G06F 3/06

(52) U.S. Cl. CPC G06F 3/0647; G06F 3/0608; G06F 3/0631; G06F 3/0679

(57) ABSTRACT

Provided in the embodiments of the present disclosure are a method and an apparatus of migrating memory data, and a non-volatile readable storage medium and an electronic apparatus. The method includes: detecting a memory using parameter of a target memory space, wherein the target memory space is a memory space that is allocated to a target application of which memory data is to be migrated, the target memory space includes a first memory space belonging to a first type and a second memory space belonging to a second type, the memory using parameter is configured to indicate a frequency distribution of the target memory space being used, and an operation efficiency of the target application for the first memory space is higher than an operation efficiency of the target application for the second memory space; selecting a third memory space from the second memory space according to the memory using parameter and a target migration parameter; and migrating first memory data stored in the third memory space to the first memory space. By means of the present disclosure, the problem of relatively low usage efficiency of a memory is solved, thereby achieving the effect of improving the usage efficiency of the memory.

### CROSS-REFERENCE TO RELATED APPLICATIONS

The present application is a National Stage Filing of the PCT International Application No. PCT/CN2024/070674 filed on Jan. 4, 2024, which claims priority to Chinese Patent Application no. 202310743575.1 filed to the China National Intellectual Property Administration on Jun. 21, 2023 and entitled “Method and Apparatus of Migrating Memory Data, and Storage Medium and Electronic Apparatus”, the entire contents of each of which are incorporated herein by reference for all purposes.

### TECHNICAL FIELD

The present disclosure relates to the field of computers, and in particular, to a method and an apparatus of migrating memory data, and a non-volatile readable storage medium and an electronic apparatus.

### BACKGROUND

With the trend of record-breaking growth in ultra-large data centers, the issue of memory requirements arises. In this case, in order to meet a requirement that an application can provide a sufficient memory space while achieving more abundant functions, a Compute Express Link (CXL) technology has been developed. CXL is an open industry-standard interconnect, which provides a high-bandwidth and low-latency connection between devices, such as a host processor and an accelerator, a memory cache area and an intelligent Input/Output (I/O) device, etc. At present, the most popular application field of the CXL technology is the expansion of a memory capacity. However, after the memory capacity is expanded, there is still a lack of a method for managing and layering a dynamic scalable memory during application usage between a local memory and the extended memory of a device.

No effective solutions have been proposed for problems of low usage efficiency of a memory in the related art.

### SUMMARY

Embodiments of the present disclosure provide a method and an apparatus of migrating memory data, and a non-volatile readable storage medium and an electronic apparatus, to at least solve the problem of low usage efficiency of a memory in the related art.

A first aspect provides a method of migrating memory data, including the following operations:
detecting a memory using parameter of a target memory space, wherein the target memory space is a memory space that is allocated to a target application of which memory data is to be migrated, the target memory space includes a first memory space belonging to a first type and a second memory space belonging to a second type, the memory using parameter is configured to indicate a frequency distribution of the target memory space being used, and an operation efficiency of the target application for the first memory space is higher than an operation efficiency of the target application for the second memory space;
selecting a third memory space from the second memory space according to the memory using parameter and a target migration parameter, wherein the target migration parameter is determined according to an allocation parameter of the target memory space, the allocation parameter is configured to indicate proportions of the first memory space and the second memory space in the target memory space, the target migration parameter is configured to indicate a proportion of a memory space, in which memory data is allowed to be migrated, in the target memory space, and the third memory space is a memory space being used in the second memory space at a frequency higher than a first frequency threshold;
migrating first memory data stored in the third memory space to the first memory space.

In an exemplary embodiment, the selecting the third memory space from the second memory space according to the memory using parameter and the target migration parameter includes the following operations:
selecting one or more memory pages of which a ratio to a plurality of memory pages is a first proportion, from the plurality of memory pages as a first memory page set according to using parameters from high to low, wherein the plurality of memory pages are memory pages in the target memory space that have stored data, the memory using parameter includes the memory pages and the using parameters, which have a correspondence relationship, each of the using parameters is configured to indicate a frequency of a corresponding memory page being used, and the target migration parameter includes the first proportion;
selecting the one or more memory pages belonging to the second memory space from the first memory page set, to obtain the third memory space.

In an exemplary embodiment, before selecting one or more memory pages of which a ratio to a plurality of memory pages is a first proportion, from the plurality of memory pages as a first memory page set according to using parameters from high to low, the method further includes the following operations:
acquiring the allocation parameter of the target memory space;
determining the first proportion according to the allocation parameter.

In an exemplary embodiment, the acquiring the allocation parameter of the target memory space includes: acquiring a first allocation proportion of the first memory space in the target memory space, wherein the allocation parameter includes the first allocation proportion;
the determining the first proportion according to the allocation parameter includes: determining a difference value between the first allocation proportion and a first preset proportion as the first proportion.

In an exemplary embodiment, the selecting the third memory space from the second memory space according to the memory using parameter and the target migration parameter includes:
dividing a plurality of memory pages into a first portion and a second portion according to using parameters from high to low, wherein a ratio of the first portion to the second portion is a target ratio, the plurality of memory pages are memory pages in the target memory space that have stored data, the memory using parameter includes the memory pages and the using parameters, which have a correspondence relationship, and each of the using parameters is configured to indicate a frequency of a corresponding memory page being used;
removing one or more memory pages, of which a ratio to the first portion is a second proportion, in the first portion according to the using parameters from low to high, to obtain a second memory page set, wherein the target migration parameter includes the target ratio and the second proportion;
selecting one or more memory pages belonging to the second memory space from the second memory page set, to obtain the third memory space.

In an exemplary embodiment, before dividing the plurality of memory pages into the first portion and the second portion according to the using parameters from high to low, the method further includes:
acquiring the allocation parameter of the target memory space;
determining the target ratio and the second proportion according to the allocation parameter.

In an exemplary embodiment, the acquiring the allocation parameter of the target memory space includes: acquiring a first allocation proportion of the first memory space in the target memory space and a second allocation proportion of the second memory space in the target memory space, wherein the allocation parameter includes the first allocation proportion and the second allocation proportion;
the determining the target ratio and the second proportion according to the allocation parameter includes: determining the first allocation proportion and the second allocation proportion as the target ratio; and acquiring a second preset proportion as the second proportion.

In an exemplary embodiment, after detecting the memory using parameter of the target memory space, the method further includes:
selecting a fourth memory space from the first memory space according to the memory using parameter and the target migration parameter, wherein the fourth memory space is a memory space being used in the first memory space at a frequency lower than a second frequency threshold;
migrating second memory data stored in the fourth memory space to the second memory space.

In an exemplary embodiment, the selecting the fourth memory space from the first memory space according to the memory using parameter and the target migration parameter includes:
selecting one or more memory pages, of which a ratio to a plurality of memory pages is a third proportion, in the plurality of memory pages as a third memory page set according to using parameters from low to high, wherein the plurality of memory pages are memory pages in the target memory space that have stored data, the memory using parameter includes the memory pages and the using parameters, which have a correspondence relationship, each of the using parameters is configured to indicate a frequency of a corresponding memory page being used, and the target migration parameter includes the third proportion;
selecting memory pages belonging to the first memory space from the third memory page set, to obtain the fourth memory space.

In an exemplary embodiment, before selecting one or more memory pages, of which a ratio to a plurality of memory pages is a third proportion, in the plurality of memory pages as a third memory page set according to using parameters from low to high, the method further includes:
acquiring the allocation parameter of the target memory space;
determining the third proportion according to the allocation parameter.

In an exemplary embodiment, the acquiring the allocation parameter of the target memory space includes: the acquiring a second allocation proportion of the second memory space in the target memory space, wherein the allocation parameter includes the second allocation proportion;

the determining the third proportion according to the allocation parameter includes: determining a difference value between the second allocation proportion and a second preset proportion as the third proportion.

In an exemplary embodiment, the selecting the fourth memory space from the first memory space according to the memory using parameter and the target migration parameter includes:
dividing a plurality of memory pages into a first portion and a second portion according to using parameters from high to low, wherein a ratio of the first portion to the second portion is a target ratio, the plurality of memory pages are memory pages in the target memory space that have stored data, the memory using parameter comprises the memory pages and the using parameters, which have a correspondence relationship, and each of the using parameters is configured to indicate a frequency of a corresponding memory page being used;
removing one or more memory pages, of which a ratio to the second portion is meet a fourth proportion, in the second portion according to the using parameters from high to low, to obtain a fourth memory page set, wherein the target migration parameter includes the target ratio and the fourth proportion;
selecting one or more memory pages belonging to the first memory space from the fourth memory page set, to obtain the fourth memory space.

In an exemplary embodiment, before dividing the plurality of memory pages into the first portion and the second portion according to the using parameters from high to low, the method further includes:
acquiring the allocation parameter of the target memory space;
determining the target ratio and the fourth proportion according to the allocation parameter.

In an exemplary embodiment, the acquiring the allocation parameter of the target memory space includes: acquiring a first allocation proportion of the first memory space in the target memory space and a second allocation proportion of the second memory space in the target memory space, wherein the allocation parameter includes the first allocation proportion and the second allocation proportion;

the determining the target ratio and the fourth proportion according to the allocation parameter includes: determining the first allocation proportion and the second allocation proportion as the target ratio; and acquiring a fourth preset proportion as the fourth proportion.

In an exemplary embodiment, the migrating first memory data stored in the third memory space to the first memory space includes:
detecting a reference remaining capacity of the first memory space;

When a data volume of the first memory data is greater than the reference remaining capacity, selecting target memory data of which data volume is the reference remaining capacity from all memory pages used in the first memory data;
migrating the target memory data to the first memory space.

In an exemplary embodiment, the detecting the memory using parameter of the target memory space includes:
collecting a use frequency of a target memory page in each time period of one or more time periods, to obtain one or more use frequencies, wherein the target memory page is each of a plurality of memory pages in the target memory space that have stored data;
calculating a using parameter corresponding to the target memory page according to the one or more use frequencies, to obtain the memory page and the using parameter, which having a correspondence relationship, as the memory using parameter.

In an exemplary embodiment, calculating the using parameter corresponding to the target memory page according to the one or more use frequencies includes:
allocating a weight to the each time period according to a difference between the each time period and a current time, wherein the smaller the difference between the each time period and the current time is, the larger the weight corresponding to the each time period becomes;
calculating a weighted sum of the one or more use frequencies by using the weight to the each time period as the using parameter corresponding to the target memory page.

In an exemplary embodiment, before detecting the memory using parameter of the target memory space, the method further includes:
detecting a usage rate of an initial memory space allocated for the target application;
adjusting the initial memory space according to a relationship between the usage rate and a usage rate threshold, to obtain the target memory space.

In an exemplary embodiment, the adjusting the initial memory space according to the relationship between the usage rate and the usage rate threshold, to obtain the target memory space includes:
when the usage rate is greater than or equal to a first usage rate threshold, allocating an additional memory space of a first capacity to the initial application, to obtain the target memory space, wherein the target memory space includes the initial memory space and the additional memory space;
when the usage rate is less than or equal to a second usage rate threshold, releasing a memory space of a second capacity from the target memory space, to obtain the target memory space.

In an exemplary embodiment, the adjusting the initial memory space includes:
detecting a target number of one or more processor cores used by the target application;
when the target number is greater than or equal to a number threshold, adjusting the initial memory space by using a first memory tool;
when the target number is less than the number threshold, adjusting the initial memory space by using a second memory tool, wherein an adjustment efficiency of the second memory tool to a memory space is lower than an adjustment efficiency of the first memory tool to the memory space, and an operating load of the second memory tool is less than an operating load of the first memory tool.

A second aspect provides an apparatus of migrating memory data, including:
a first detection module, configured to detect a memory using parameter of a target memory space, wherein the target memory space is a memory space that is allocated to a target application of which memory data is to be migrated, the target memory space includes a first memory space belonging to a first type and a second memory space belonging to a second type, the memory using parameter is configured to indicate a frequency distribution of the target memory space being used, and an operation efficiency of the target application for the first memory space is higher than an operation efficiency of the target application for the second memory space;
a first selecting module, configured to select a third memory space from the second memory space according to the memory using parameter and a target migration parameter, wherein the target migration parameter is determined according to an allocation parameter of the target memory space, the allocation parameter is configured to indicate proportions of the first memory space and the second memory space in the target memory space, the target migration parameter is configured to indicate a proportion of a memory space, in which memory data is allowed to be migrated, in the target memory space, and the third memory space is a memory space being used in the second memory space at a frequency higher than a first frequency threshold;
a first migration module, configured to migrate first memory data stored in the third memory space to the first memory space.

A third aspect further provides a non-volatile computer-readable storage medium. The non-volatile computer-readable storage medium stores a computer program. Steps in any one of the above method embodiments are executed when the computer program is configured to run.

A fourth aspect further provides an electronic device. The electronic device includes a memory and a processor. The memory is configured to store a computer program. The processor is configured to run the computer program to execute steps in any one of the above method embodiments.

Through the present disclosure, the target memory space used by the target application includes the first memory space and the second memory space. The memory space, which is the third memory space needs to be migrated, being used at a high frequency in the second memory space is screened from the target memory space according to the frequency distribution of the target memory space being used and the allocation parameter of the target memory space. Because the operation efficiency of the target application for the first memory space is higher than the operation efficiency of the target application for the second memory space, by migrating the first memory data stored in partial memory space with high usage efficiency in the second memory space to the first memory space, the operation efficiency of the target application to the memory data with high usage efficiency is improved, thereby improving the operation efficiency of the target application. Therefore, the problem of relatively low usage efficiency of a memory may be solved, thereby achieving the effect of improving the usage efficiency of the memory.

### BRIEF DESCRIPTION OF THE DRAWINGS

FIG. 1 is a block diagram of a hardware structure of a mobile terminal of a method of migrating memory data according to embodiments of the present disclosure.

FIG. 2 is a flowchart of a method of migrating memory data according to embodiments of the present disclosure.

FIG. 3 is a schematic diagram of a memory using parameter determination process according to embodiments of the present disclosure.

FIG. 4 is a flowchart of allocation of an initial memory space for a target application according to embodiments of the present disclosure.

FIG. 5 is a flowchart of dynamic distribution of a memory space according to embodiments of the present disclosure.

FIG. 6 is a schematic diagram of screening of a fourth memory space from a first memory space according to embodiments of the present disclosure.

FIG. 7 is a schematic diagram of screening of a third memory space from a second memory space according to embodiments of the present disclosure.

FIG. 8 is a schematic diagram of execution of memory data migration in a first memory space and a second memory space according to embodiments of the present disclosure.

FIG. 9 is a structural block diagram of an apparatus of migrating memory data according to embodiments of the present disclosure.

FIG. 10 is a schematic diagram of an electronic device according to embodiments of the present disclosure.

### DETAILED DESCRIPTION OF THE EMBODIMENTS

The embodiments of the present disclosure are described below in detail with reference to the drawings and the embodiments.

It is to be noted that terms “first”, “second” and the like in the description, claims and the above mentioned drawings of the present disclosure are used for distinguishing similar objects rather than describing a specified sequence or a precedence order.

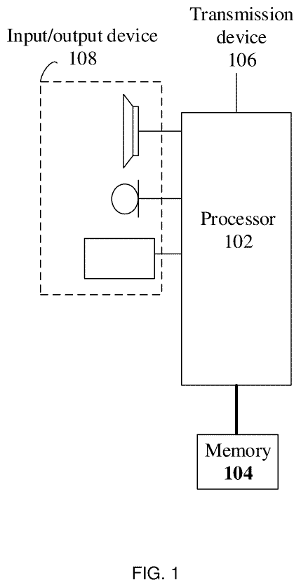

The method embodiments provided in the embodiments of the present disclosure may be executed in a mobile terminal, a computer terminal or a similar computing apparatus. By being operated on the mobile terminal as an example, FIG. 1 is a block diagram of a hardware structure of a mobile terminal of a method of migrating memory data according to embodiments of the present disclosure. As shown in FIG. 1, the mobile terminal may include one or more (only one is shown in FIG. 1) processors 102 (the processor 102 may include, but is not limited to, a processing apparatus such as a microprocessor MCU or a programmable logic device FPGA) and a memory 104 configured to store data. The above mobile terminal may further include a transmission device 106 configured to achieve a communication function, and an input/output device 108. Those skilled in the art may understand that the structure shown in FIG. 1 is only a schematic diagram, which does not limit the structure of the above mobile terminal. For example, the mobile terminal may also include more or less components than those shown in FIG. 1, or have a different configuration from that shown in FIG. 1.

The memory 104 may be configured to store a computer program, for example, a software program and a module of application software, such as a computer program corresponding to a memory data migration method in the embodiments of the present disclosure. The processor 102 runs the computer program stored in the memory 104, so as to execute various functional applications and data processing, that is, to realize the above method. The memory 104 may include a high-speed random access memory, and may further include a non-volatile memory, such as one or more magnetic disk memory apparatuses, a flash memory device, or other non-volatile solid-state memory devices. In some examples, the memory 104 may include memories remotely disposed relative to the processor 102, and these remote memories may be connected to the mobile terminal via a network. Examples of the above network include, but are not limited to, the Internet, an intranet, a local area network, a mobile communication network, and a combination thereof.

The transmission device 106 is configured to receive or send data via the network. The example of the above network may include a wireless network provided by a communication provider of the mobile terminal. In an example, the transmission device 106 includes a Network Interface Controller (NIC), and may be connected to other network devices by using a base station, so as to communicate with the Internet. In an example, the transmission device 106 is a Radio Frequency (RF) module, which is configured to communicate with the Internet in a wireless manner.

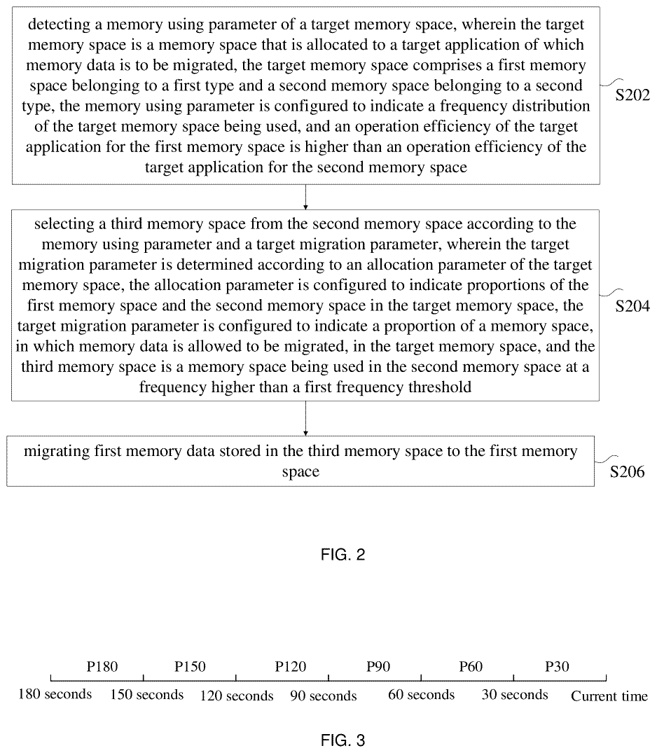

This embodiment provides a memory data migration method operated on the computer terminal. FIG. 2 is a flowchart of a method of migrating memory data according to embodiments of the present disclosure. As shown in FIG. 2, the flow includes the following steps.

At S202, detecting a memory using parameter of a target memory space, wherein the target memory space is a memory space that is allocated to a target application of which memory data is to be migrated, the target memory space includes a first memory space belonging to a first type and a second memory space belonging to a second type, the memory using parameter is configured to indicate a frequency distribution of the target memory space being used, and an operation efficiency of the target application for the first memory space is higher than an operation efficiency of the target application for the second memory space;

At S204, selecting a third memory space from the second memory space according to the memory using parameter and a target migration parameter, wherein the target migration parameter is determined according to an allocation parameter of the target memory space, the allocation parameter is configured to indicate proportions of the first memory space and the second memory space in the target memory space, the target migration parameter is configured to indicate a proportion of a memory space, in which memory data is allowed to be migrated, in the target memory space, and the third memory space is a memory space being used in the second memory space at a frequency higher than a first frequency threshold;

At S206, migrating first memory data stored in the third memory space to the first memory space.

Through the above steps, the target memory space used by the target application includes the first memory space and the second memory space. The memory space, which is the third memory space needs to be migrated, being used at a high frequency in the second memory space is screened from the target memory space according to the frequency distribution of the target memory space being used and the allocation parameter of the target memory space. Because the operation efficiency of the target application for the first memory space is higher than the operation efficiency of the target application for the second memory space, by migrating the first memory data stored in partial memory space with high usage efficiency in the second memory space to the first memory space, the operation efficiency of the target application to the memory data with high usage efficiency is improved, thereby improving the operation efficiency of the target application. Therefore, the problem of relatively low usage efficiency of a memory may be solved, thereby achieving the effect of improving the usage efficiency of the memory.

In the technical solution provided in S202, the method of migrating memory data may, but is not limited to, implement memory expansion on a server hardware system through a CXL protocol, for example: the server hardware system implements the remote sharing of non-local Dynamic Random Access Memories (DRAMs) and the sharing of IO devices through a Peripheral Component Interconnect Express 5 (PCIe 5) protocol, so as to expand a manner of transmitting a processor and a Double Data Rate Dynamic Random Access Memory (DDR DRAM) in a computer, such that a remote shared memory provides higher memory capacity and performance for the system.

Optionally, in this embodiment, the method of migrating memory data may, but is not limited to, be applied to the server hardware system supporting the CXL protocol. The server hardware system may include, but is not limited to, a Central Processing Unit (CPU) supporting the CXL protocol, a chip set supporting the CXL protocol, a hardware device supporting the CXL protocol, an operating system supporting the CXL protocol, etc. The CXL protocol may include, but is not limited to, a CXL1.1 protocol, a CXL1.0 protocol, a CXL2.0 protocol, etc.

Optionally, in this embodiment, the method of migrating memory data may, but is not limited to, be applied to the operating system supporting the CXL protocol, such as a Linux system (GNU/Linux), a Windows operating system (Microsoft Windows, the Microsoft Corporation uses a graphical user interface as a basic research and development operating system), a VMware ESXi system (virtualization software supporting the running of a windows platform), etc. For example, the Linux system supports the CXL protocol and the Linux system includes a local memory and an expanded CXL memory, the Linux system may, but is not limited to, manage the expanded CXL memory through the following manners.

A corresponding driver and an interface related to the CXL memory are developed based on Linux6.2, and a CXL memory capacity and an address are identified according to Static Resource Affinity Table (SRAT) and e820 (a data structure for describing a system memory layout). When the Linux operating system is started, an external CXL memory is automatically identified as a Random Access Memory (RAM), and a CXL memory attribute is automatically identified and modified as soft reserved (a memory attribute, indicating that a memory area has been allocated but not yet used). The local memory and the CXL memory are distinguished by using buddyinfo (a Linux command, which is configured to check Buddy Allocator information in a system), and are mapped into different groups (Normal Memory, Cxl Memory), that is, (local memory, CXL memory). A Serial Linked Interface Technology (SLIT) is used to read a distance between the CXL memory and a host processor, the number of slots used by the CXL memory is recorded, and the number of bandwidths that may be provided by the CXL memory is calculated according to the number of slots used by the CXL memory. By modifying a Non-Uniform Memory Access (NUMA) node Application Programming Interface (API), a user can use the API to modify a NUMA node of the CXL memory in a terminal or a program.

Optionally, in this embodiment, the target application may be, but is not limited to, operated in the server hardware system supporting the CXL protocol. The server hardware system supporting the CXL protocol can operate one or more target applications, and may, but is not limited to, determine the one or more applications operated in the server hardware system supporting the CXL protocol as the target application.

Optionally, in this embodiment, memory spaces from two different sources may be, but are not limited to, allocated for the target application at a system startup phase, so as to obtain the target memory space. Alternatively, the memory space of the target application may be, but is not limited to, adjusted in real time according to requirements of the target application for the memory space during the operation of the target application, so as to obtain a new target memory space.

Optionally, in this embodiment, the first memory space belonging to the first type and the second memory space belonging to the second type may be, but are not limited to, connected to a system in which the target application is located in two different manners. The first type and the second type are configured to indicate that the manners for connecting the first memory space and the second memory space to the system in which the target application is located are different.

Optionally, in this embodiment, the first memory space belonging to the first type may be, but is not limited to, a local memory in the system in which the target application is located. The second memory space belonging to the second type may be, but is not limited to, an external memory of the system in which the target application is located, for example, the CXL memory, such that a remote memory may, but is not limited to, be used as the local memory through the CXL technology. For example, the external memory is the CXL memory, since the closer CXL memory, that is, a physical distance between the host processor and the remote memory, can provide a faster data transmission speed and lower latency, and the distant CXL memory may generate higher access latency and a slower data transmission speed, the operation efficiency of the target application for the local first memory space is higher than the operation efficiency of the target application for the distant second memory space.

Optionally, in this embodiment, the second memory space belonging to the second type may, but is not limited to, be connected to the system in which the target application is located in the following manners: the CXL memory (i.e., the second memory space) is connected to a system server through the PCIe interface, after a server is powered on, a Basic Input Output System (BIOS) identifies the CXL memory and records related CXL memory mapped addresses and attributes to the SRAT, and records a NUMA node distance.

Optionally, in this embodiment, the target memory space may include, but is not limited to, a plurality of memory pages. A storage operation of data may, but is not limited to, be executed on the memory page. The first memory space belonging to the first type and the second memory space belonging to the second type may include, but are not limited to, a plurality of memory pages with different sizes, for example: memory pages with a size of 2 G, memory pages with a size of 1 M, memory pages with a size of 2 KB, etc. The memory pages with corresponding sizes and numbers may, but are not limited to, be allocated for the target application according to different data volumes need to be stored by the target application.

Optionally, in this embodiment, the memory using parameter of the target memory space is configured to indicate the frequency distribution of the target memory space being used. The memory using parameter of the target memory space may, but is not limited to, be determined by the following methods: by using each memory page in the target memory space as a unit, the number of times for using each memory page in the target memory space within a period of time is detected, then the memory pages are sorted according to the number of times for using each memory page within the period of time, to obtain memory pages in the target memory space that are distributed in an interval with a high use frequency, memory pages in the target memory space that are distributed in an interval with a low use frequency, and memory pages in the target memory space that are distributed in an interval with a stable use frequency, and the interval obtained according to the number of times for using is determined as the memory using parameter of the target memory space.

In an exemplary embodiment, the memory using parameter of the target memory space may, but is not limited to, be detected by using the following manners: a use frequency of a target memory page in each time period of one or more time periods are collected, to obtain one or more use frequencies, wherein the target memory page is each of a plurality of memory pages in the target memory space that have stored data; a using parameter corresponding to the target memory page is calculated according to the one or more use frequencies, to obtain a memory page (namely, the target memory page) and the using parameter, which having a correspondence relationship, as the memory using parameter.

Optionally, in this embodiment, the target application may include, but is not limited to, the plurality of memory pages, and the memory page for storing data may, but is not limited to, be determined as the memory page. The memory page for storing data in the target application may, but is not limited to, be determined as the target memory page.

Optionally, in this embodiment, the number of times for using the memory page for storing data in the target application within each time period of one or more time periods is determined as a use frequency of the target memory space. For example: the target application includes N memory pages storing data, and the N memory pages storing data are used for M times within one time period, such that the M times are determined as the use frequency of the target memory page. Alternatively, the target application includes N memory pages storing data, and the N memory pages storing data are used for M1 times . . . MP times with in each of P time periods, such that the M1 times . . . MP times are all determined as the use frequency of the target memory page.

Optionally, in this embodiment, the corresponding using parameter may, but is not limited to, be determined according to the use frequency of the target memory page. For example: the target application includes N memory pages storing data, and the N memory pages storing data are used for M times within one time period, such that the M times are determined as the use frequency of the target memory page, and the corresponding using parameter M is determined according to the use frequency M. Alternatively, the target application includes N memory pages storing data, and the N memory pages storing data are used for M1 times . . . MP times with in each of P time periods, such that the M1 times . . . MP times are all determined as the use frequency of the target memory page, and the corresponding using parameter M is determined as a sum of M1. MP according to the use frequencies M1 . . . . MP.

In an exemplary embodiment, the using parameter corresponding to the target memory page may, but is not limited to, be calculated according to one or more use frequencies by using the following manners: a weight to each time period is allocated according to a difference between the each time period and a current time, wherein the smaller the difference between the each time period and the current time is, the larger the weight corresponding to the each time period becomes; and a weighted sum of the one or more use frequencies by using the weight to the each time period is calculated as the using parameter corresponding to the target memory page.

Optionally, in this embodiment, the weight of each time period may, but is not limited to, be determined according to the distance between each time period and the current time, for example: the target application includes N memory pages storing data, the N memory pages storing data are respectively used for M1, M2, and M3 times at a time period P1, a time period P2, and a time period P3, the corresponding weight is T1, T2, and T3, because the time period P1 is closest to the current time, a distance between the time period P2 and the current time is longer than a distance between the time period P1 and the current time, and the time period P3 is furthest from the current time, such that T1>T2>T3.

In an optional implementation, an example of a process of determining the memory using parameter of the target memory space is provided. FIG. 3 is a schematic diagram of a memory using parameter determination process according to embodiments of the present disclosure. As shown in FIG. 3, the memory using parameter of the target memory space may, but is not limited to, be determined by the following manners:

the use frequencies of the target memory page for a time period being determined as every 30 seconds within 180 seconds from a current moment are collected, so as to obtain the use frequencies P for each time period within 180 seconds from the current moment, including P30, P60, P90, P120, P150, and P180;
the weight T is allocated to each time period according to the distance between each time period and the current time: T30, T60, T90, T120, T150, and T180, where T30 is greater than T60, T60 is greater than T90, T90 is greater than T120, T120 is greater than T150, and T150 is greater than T180;
the sum of the weights T of each use frequency P within 180 seconds is used as the using parameter S corresponding to the target memory page:

$$S = T 180 * P 180 + T 150 * P 150 + T 120 * P 120 + T 90 * P 90 + T 60 * P 60 + T 30 * P 30.$$

In an exemplary embodiment, before the memory using parameter of the target memory space is detected, the target memory space may, but is not limited to, be obtained by using the following manners: a usage rate of an initial memory space allocated for the target application is detected; and the initial memory space is adjusted according to a relationship between the usage rate and a usage rate threshold, to obtain the target memory space.

Optionally, in this embodiment, the system in which the target application is located may, but is not limited to, automatically allocate the initial memory space for the target application at the startup phase, and the initial memory space may include, but is not limited to, a memory space belonging to the first type and a memory belonging to the second type.

Optionally, in this embodiment, the initial memory space of the target application may, but is not limited to, be a particular size. For example: the initial memory space may, but is not limited to, be a M-sized memory space of the first type and a M-sized memory space of the second type, or the M-sized memory space of the first type and the N-sized memory space of the second type, where M and N are natural numbers greater than or equal to zero, and M is not equal to N.

Optionally, in this embodiment, the initial memory space of the target application may, but is not limited to, be an appropriate initial memory space that is allocated to the target application according to a historical situation of a memory occupied by the target application. For example: the initial memory space is allocated to the target application according to a median of the maximum usage of the memory space of the first type and the memory space of the second type when the target application is used for P times recently.

Optionally, in this embodiment, the usage rate of the initial memory space may, but is not limited to, be determined based on an occupation situation of the target application to the memory space. For example: the memory is managed by Bitmap, and whether a memory block in the target application is in a used state or an idle state is tracked.

Optionally, in this embodiment, the usage rate of the initial memory space may, but is not limited to, be determined according to whether the demand of the target application for the initial memory space exceeds the initial memory space. Alternatively, the usage rate of the initial memory space may, but is not limited to, be determined according to whether the demand of the target application for the initial memory space is much less than the initial memory space.

Optionally, in this embodiment, the usage rate threshold may, but is not limited to, be predetermined, or modified in real time according to a memory situation of the target application. The usage rate threshold may, but is not limited to, be configured to determine whether the occupation situation of the target application to the initial memory space is in a balance state. For example, when the usage rate of the initial memory space of the target application exceeds the usage rate threshold, it is determined that the demand of the target application for the initial memory space is greater than a capacity of the initial memory space, so as to indicate that a capacity expansion operation needs to be performed on the initial memory space. Alternatively, when the usage rate of the initial memory space of the target application is less than the usage rate threshold, it is determined that the demand of the target application for the initial memory space is much less than the capacity of the initial memory space, so as to indicate that an operation of reducing a certain memory space may be performed on the initial memory space.

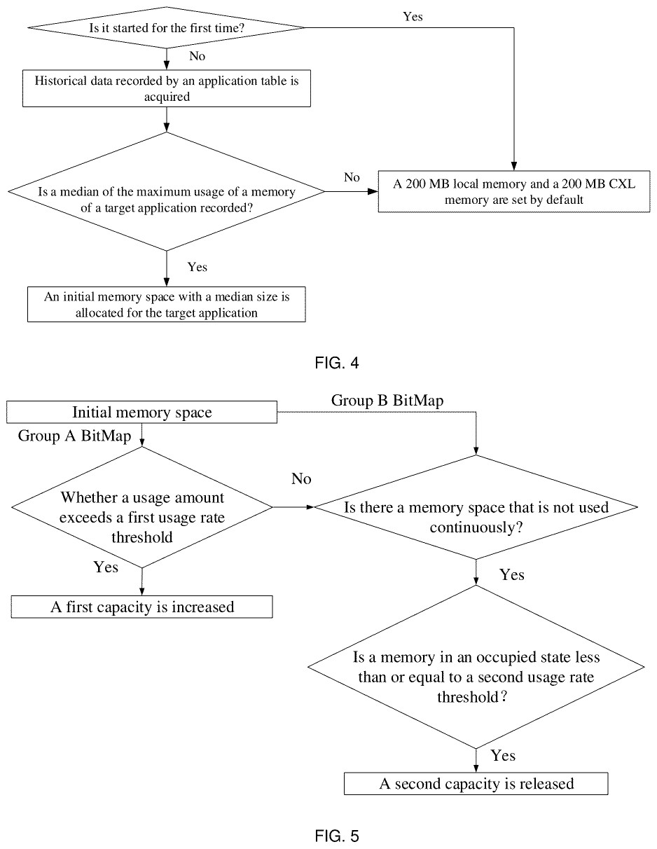

In an optional implementation, a process of allocating the initial memory space for the target application is provided. FIG. 4 is a flowchart of allocation of an initial memory space for a target application according to embodiments of the present disclosure. As shown in FIG. 4, the initial memory space may, but is not limited to, be allocated for the target application through the following manners.

When the system is started for the first time, a pre-allocated memory (the initial memory space) including a local memory capacity (the memory space of the first type) and a CXL memory capacity (the memory space of the second type) is allocated for the target application according to a set fixed value, the allocated memory is implemented by a red black tree data structure, that is, the close CXL memory is used preferentially, the maximum use amounts of the local memory and the CXL memory by each application are recorded by using an application table, and a median of the maximum use amounts is calculated, and in addition, a use core mean value of each application is also recorded. The number and offset of size_class (indicating the size that needs to be aligned for the size of the memory allocated in the initial memory space) of each memory page in the initial memory space are recorded by using a memory pool table.

When the system is not started for the first time, for example, the maximum usage of the memory space of the first type and the memory space of the second type when the target application is used for P=20 times before current startup is acquired from the application table, automatic pre-allocation of the memory (the initial memory space) is set, the allocated capacity is median data of the maximum usage of the memory space of the first type and the memory space of the second type saved by the application table, and if there is no median data, 200 MB of the local memory and 200 MB of the CXL memory are set by default.

In an exemplary embodiment, the initial memory space is adjusted according to the relationship between the usage rate and the usage rate threshold, and the target memory space may, but is not limited to, be obtained by using the following manners: when the usage rate is greater than or equal to a first usage rate threshold, an additional memory space of a first capacity is allocated to the target application, to obtain the target memory space, where the target memory space includes the initial memory space and the additional memory space; and when the usage rate is less than or equal to a second usage rate threshold, a memory space of a second capacity is released from the initial memory space, to obtain the target memory space.

Optionally, in this embodiment, the first usage rate threshold may, but is not limited to, be predetermined, or modified in real time according to a memory situation of the target application.

Optionally, in this embodiment, the first usage rate threshold may, but is not limited to, be configured to determine whether the occupation situation of the target application to the initial memory space is in an overloaded state. For example, when the usage rate of the initial memory space of the target application is greater than or equal to the first usage rate threshold, it is determined that the demand of the target application for the initial memory space is greater than a capacity of the initial memory space, so as to perform a capacity expansion operation on the initial memory space.

Optionally, in this embodiment, the first capacity of the additional memory space may, but is not limited to, be determined according to the occupation situation of the target application to the initial memory space. Alternatively, when the usage rate is greater than or equal to the first usage rate threshold, the additional memory space of a fixed capacity is allocated for the target application. For example, when the usage rate is greater than or equal to the first usage rate threshold, 200 MB of the additional memory space is allocated for the target application.

Optionally, in this embodiment, the additional memory space may be acquired from the memory space of the first type, or may be acquired from the memory space of the second type.

Optionally, in this embodiment, the second usage rate threshold may, but is not limited to, be predetermined, or modified in real time according to a memory situation of the target application. The second usage rate threshold may, but is not limited to, be configured to indicate an occupation situation of a memory to the target application within a certain time. For example: if the target application does not use partial memory space of the initial memory space within the certain time, it may be considered that the initial memory space is in a no-load state. Alternatively, a difference value between a total capacity in which the memory in an occupied state in the initial memory space within the certain time is less than or equal to the initial memory space and the partial memory space that is not used in the initial memory space within the certain time is determined as the second usage rate threshold.

Optionally, in this embodiment, the second usage rate threshold may, but is not limited to, be configured to determine whether the occupation situation of the target application to the initial memory space is in a no-load state. For example, when the usage rate of the initial memory space of the target application is less than or equal to the second usage rate threshold, it is determined that the capacity of the initial memory space is much greater than the demand of the target application for the memory space, and an operation of reducing partial memory space needs to be performed on the initial memory space.

Optionally, in this embodiment, the second capacity may, but is not limited to, be determined according to the occupation situation of the target application to the initial memory space. Alternatively, when the usage rate is less than or equal to the second usage rate threshold, the memory space of a fixed capacity in the target application is reduced. For example, when the usage rate is less than or equal to the second usage rate threshold, 200 MB of the memory space is reduced from the target application.

In an optional implementation, a process of performing dynamic allocation on the initial memory space of the target application is provided. FIG. 5 is a flowchart of dynamic distribution of a memory space according to embodiments of the present disclosure. As shown in FIG. 5, for example, memory usage situations in 2 groups of BitMap management memory pools (initial memory space) are set, dynamic allocation may, but is not limited to, be performed on the initial memory space of the target application through the following processes, where the 2 groups of BitMap respectively are Group A BitMap and Group B BitMap.

The Group A BitMap detects whether a memory is used in real time, may flexibly allocate the memory when an application is operated, and may, but is not limited to, monitor an occupation situation of the memory in the memory pool in real time. For example, when the memory used in the memory pool (including the memory space of the first type and the memory space of the second type) exceeds 90% (first usage rate threshold) of the corresponding capacity in the memory pool, a memory allocation API is called, and a 200 MB memory capacity (first capacity) is increased.

The Group B BitMap manages the usage situation of the memory within a certain time. For example, if there is a memory space being not used in the memory pool within 5 min, and the memory in the occupied state in the memory pool (including the memory space of the first type and the memory space of the second type) is less than or equal to a difference value (second usage rate threshold) between a total capacity of the memory pool and 90% (second usage rate threshold) of the memory space being not used within 5 min, the useless memory (second capacity) being not used is released.

In an exemplary embodiment, the initial memory space may, but is not limited to, be adjusted by using the following manners: a target number of one or more processor cores used by the target application is detected; when the target number is greater than or equal to a number threshold, the initial memory space is adjusted by using a first memory tool; and when the target number is less than the number threshold, the initial memory space is adjusted by using a second memory tool, wherein an adjustment efficiency of the second memory tool to a memory space is lower than an adjustment efficiency of the first memory tool to the memory space, and an operating load of the second memory tool is less than an operating load of the first memory tool.

Optionally, in this embodiment, the number threshold may, but is not limited to, be preset, and is configured to select a tool for adjusting the memory space according to the target number of the processor cores used by the target application.

Optionally, in this embodiment, the adjustment efficiency of the second memory tool to the memory space is lower than the adjustment efficiency of the first memory tool to the memory space, but the operating load of the second memory tool is less than the operating load of the first memory tool. For example, the first memory tool may be, but is not limited to, a tcmalloc allocator (an efficient memory allocator, which may perform memory allocation and releasing operations more quickly and efficiently), and the second memory tool may be, but is not limited to, a jemalloc allocator (a general and thread-safe memory allocator).

In an optional implementation, a process of adjusting the initial memory space is provided. The initial memory space may, but is not limited to, be adjusted through the following manners: a mean value of the processor cores used by each application is recorded through a table, the tcmalloc allocator is used when the number of the processor cores used by the application is not greater than 3 (number threshold), the jemalloc allocator is used when the number of the processor cores used by the application is greater than 3, and if there is no record in the application table, the tcmalloc allocator is used by default.

In an exemplary embodiment, after the memory using parameter of the target memory space is detected, the following manners may, but are not limited to, be used: a fourth memory space is selected from the first memory space according to the memory using parameter and the target migration parameter, wherein the fourth memory space is a memory space being used in the first memory space at a frequency lower than a second frequency threshold; and second memory data stored in the fourth memory space is migrated to the second memory space.

Optionally, in this embodiment, the target memory space may, but is not limited to, be divided into N intervals through the target migration parameter, to indicate the proportion of the memory space in the target memory space that allows to migrate the memory data. The target migration parameter of the target memory space may, but is not limited to, be determined according to the proportions of the first memory space and the second memory space in the target memory space. For example, the proportion of the first memory space in the target memory space is A, the proportion of the second memory space in the target memory space is 100−A, and the target migration parameter is (A−10):20:(90−A). Alternatively, the proportion of the first memory space in the target memory space is A, the proportion of the second memory space in the target memory space is 100−A, and the target migration parameter is A:(100−A).

Optionally, in this embodiment, the memory using parameter may, but is not limited to, be determined according to the allocation parameter of the target memory space, the proportions of the first memory space and the second memory space in the target memory space may, but are not limited to, be determined as the allocation parameter of the target memory space, and the allocation parameter of the target memory space may, but is not limited to, be determined when the target memory space is allocated for the target application. For example, the target memory space allocated for the target application includes the first memory space of an A capacity and the second memory space of a B capacity, and the allocation parameter of the target memory space includes the proportion A/(A+B) of the first memory space in the target memory space and the proportion B/(A+B) of the second memory space in the target memory space.

Optionally, in this embodiment, the second frequency threshold may, but is not limited to, be predetermined, and is configured to select the memory space being used at a high frequency in the second memory space.

Optionally, in this embodiment, partial memory space being used at a high frequency in the first memory space may, but is not limited to, be determined as the fourth memory space. Since the operation efficiency of the target application for the first memory space is higher than the operation efficiency of the target application for the second memory space, partial memory space being used at a low frequency in the first memory space is migrated to the second memory space, causing the operation efficiency of the target application to improve.

In an exemplary embodiment, the fourth memory space may, but is not limited to, be selected from the first memory space according to the memory using parameter and the target migration parameter by using the following manners: one or more memory pages, of which a ratio to a plurality of memory pages is a third proportion, in the plurality of memory pages are selected as a third memory page set according to using parameters from low to high, wherein the plurality of memory pages are memory pages in the target memory space that have stored data, the memory using parameter includes the memory pages and the using parameters, which have a correspondence relationship, each of the using parameters is configured to indicate a frequency of a corresponding memory page being used, and the target migration parameter includes the third proportion; and the memory pages belonging to the first memory space are selected from the third memory page set, to obtain the fourth memory space.

Optionally, in this embodiment, the using parameter may be, but is not limited to, the use frequency of each memory page in the target memory space of the target application. For example, the target memory space includes the plurality of memory pages, for each operation (which may include, but is not limited to, adding, deleting, finding, modifying, etc.) performed on the memory page within one or more time periods, the number of times for using the memory page adds 1, a sum of the number of times for using the memory page within the one or more time periods is obtained, and then the sum of the number of times for performing the operation is weighted according to a distance between the time period in which the operation is performed and the current time, so as to obtain the using parameter of each memory page.

Optionally, in this embodiment, the plurality of memory pages may, but are not limited to, be sorted according to the using parameter. For example, each memory page is sorted from high to low according to the using parameter. Alternatively, each memory page is sorted from low to high according to the using parameter.

Optionally, in this embodiment, the third proportion is configured to indicate the memory pages that meet a certain proportion of the target memory page. The third proportion may, but is not limited to, be determined according to the target migration parameter. For example, the target migration parameter of the target memory space is A:(100−A), and (100−A) may, but is not limited to, be determined as the third proportion. Alternatively, the target migration parameter of the target memory space is (A−10):20:(90−A), and (90−A) may, but is not limited to, be determined as the third proportion.

Optionally, in this embodiment, the third memory page set is the memory pages that are used in the target memory page at the lowest frequency and meet the third proportion. For example, the third proportion is 20%, the target memory space includes 100 memory pages, according to the frequency of the memory page being used, the memory pages are sorted according to a sequence from the memory page being used at a low frequency to the memory page being used at a high frequency, and 20 memory pages being used at the highest frequency are selected from low to high as the third memory page set.

Optionally, in this embodiment, the memory pages belonging to the first memory space among the memory pages being used at the highest frequency may, but are not limited to, be determined as the fourth memory space. For example, the third memory page set includes 100 memory pages, 50 memory pages belonging to the first memory space are found from the third memory page set, and the 50 memory pages belonging to the first memory space in the third memory page set are determined as the fourth memory space.

In an exemplary embodiment, before selecting one or more memory pages, of which a ratio to a plurality of memory pages is a third proportion, in the plurality of memory pages as a third memory page set according to using parameters from low to high, the third proportion may, but is not limited to, be determined by using the following manners: the allocation parameter of the target memory space is acquired; and the third proportion is determined according to the allocation parameter.

Optionally, in this embodiment, the allocation parameter of the target memory space may be, but is not limited to, proportions of the first memory space and the second memory space in the target memory space. For example: the target memory space includes the first memory space with the proportion being A % and the second memory space with the proportion being (100%−A %), and the allocation parameter of the target memory space includes A % and B %=(100%−A %).

Optionally, in this embodiment, the allocation parameter of the target memory space may, but is not limited to, be determined as the third proportion of the target memory space. For example, the allocation parameter of the target memory space includes A % and B %=(100%−A %), the memory pages may, but are not limited to, be sorted according to the using parameter, (100%−A %) is the third proportion, and the lowest A % is selected as the third memory page set from low to high. Alternatively, for example, the allocation parameter of the target memory space includes A %−C %: 2C %: 100%−C %−A %, the memory pages may, but are not limited to, be sorted according to the using parameter, 100%−C %−A % is the third proportion, and the lowest 100%-C %-A % is selected as the third memory page set from high to low.

In an exemplary embodiment, the allocation parameter of the target memory space may, but is not limited to, be acquired by using the following manner: a second allocation proportion of the second memory space in the target memory space is acquired, wherein the allocation parameter includes the second allocation proportion. The third proportion may, but is not limited to, be determined by using the following manner: a difference value between the second allocation proportion and a second preset proportion is determined as the third proportion.

Optionally, in this embodiment, the proportion of the second memory space in the target memory space may, but is not limited to, be determined as the second allocation proportion.

Optionally, in this embodiment, the second preset proportion may, but is not limited to, be predetermined, and is configured to determine the first proportion from the second allocation proportion.

Optionally, in this embodiment, the third proportion may, but is not limited to, be determined according to the proportion of the second memory space in the target memory space and the second preset proportion. For example, the second preset proportion is 20%, the proportion of the second memory space in the target memory space is A %, and the third proportion may be, but is not limited to, A %−20%.

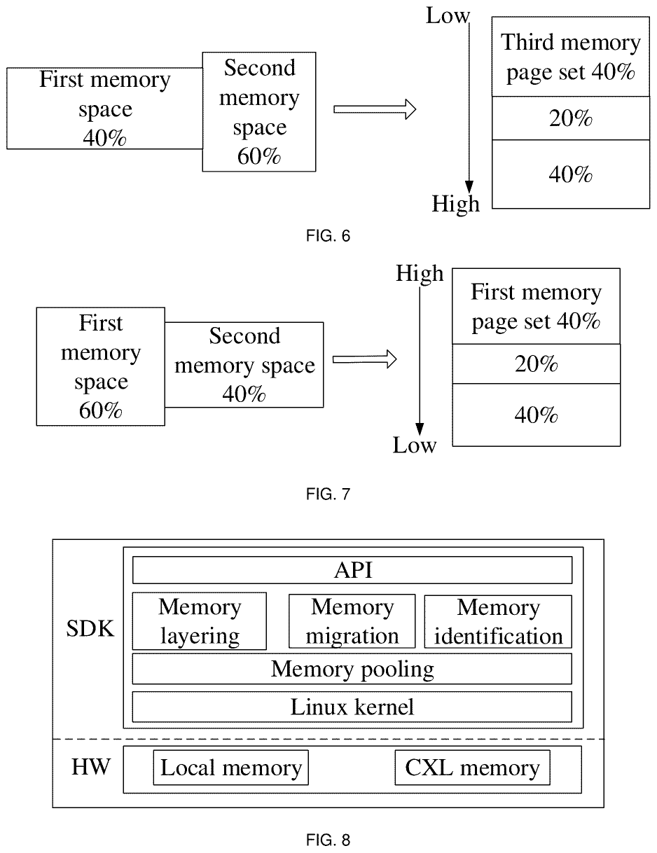

In an exemplary embodiment, an example of screening the fourth memory space from the first memory space is provided. FIG. 6 is a schematic diagram of screening of a fourth memory space from a first memory space according to embodiments of the present disclosure. As shown in FIG. 6, for example, the second preset proportion is 20%, the fourth memory space may, but is not limited to, be determined through the following processes:
the first memory space: the second memory space in the allocation parameter of the target memory space is 40%:60%, the target migration parameter is determined to be 40%:60% according to the allocation parameter of the target memory space, and the target memory space is sorted from low to high according to the memory using parameter;
the third proportion is determined to be 60%−20%=40% according to the target migration parameter being 40%: 60% and the second preset proportion being 20%, and the last 40% is determined as the third memory page set;
the memory pages belonging to the first memory space are acquired as the fourth memory space from the third memory page set.

In an exemplary embodiment, the fourth memory space may, but is not limited to, be selected from the first memory space according to the memory using parameter and the target migration parameter by using the following manners: a plurality of memory pages are divided into a first portion and a second portion according to using parameters from high to low, wherein a ratio of the first portion to the second portion is a target ratio, the plurality of memory pages are memory pages in the target memory space that have stored data, the memory using parameter includes the memory pages and the using parameters, which have a correspondence relationship, and each of the using parameters is configured to indicate a frequency of a corresponding memory page being used; one or more memory pages, of which a ratio to the second portion is meet a fourth proportion, in the second portion according to the using parameters from high to low, to obtain a fourth memory page set, wherein the target migration parameter includes the target ratio and the fourth proportion; and one or more memory pages belonging to the first memory space are selected from the fourth memory page set, to obtain the fourth memory space.

Optionally, in this embodiment, each memory page in the target memory space may, but is not limited to, be divided according to the use frequency of each memory page in the target memory space, to obtain the first portion with a high use frequency and the second portion with a low use frequency.

Optionally, in this embodiment, the target ratio of the first portion to the second portion may, but is not limited to, be determined according to the proportions of the first memory space and the second memory space in the target memory space. For example, the proportion of the first memory space in the target memory space is A %, the proportion of the second memory space is B %=(100%−A %), the target memory space may, but is not limited to, be sorted from high to low according to the using parameters, the first A % is divided into the first portion, and the last B % is divided into the second portion.

Optionally, in this embodiment, the second proportion may, but is not limited to, be obtained by dividing a portion of memory spaces from the proportions of the first memory space and the second memory space in the target memory space.

Optionally, in this embodiment, the memory pages of the fourth proportion with the highest using parameter may, but are not limited to, be removed from the second portion, so as to obtain the fourth memory page set. For example, the fourth proportion is 10%, the target memory space is arranged from high to low according to the using parameter, the first A % is divided into the first portion, the last B % is divided into the second portion, and then 10% is removed from the second portion from high to low, so as to obtain the fourth memory page set.

Optionally, in this embodiment, the memory pages belonging to the first memory space in the fourth memory page set may, but are not limited to, be determined as the fourth memory space.

In an exemplary embodiment, before the plurality of memory pages are divided into the first portion and the second portion according to the using parameters from high to low, the following manners may, but are not limited to, be used: the allocation parameter of the target memory space is acquired; and the target ratio and the fourth proportion are determined according to the allocation parameter.

Optionally, in this embodiment, the allocation parameter of the target memory space may be, but is not limited to, proportions of the first memory space and the second memory space in the target memory space. For example, the target memory space includes the first memory space with the proportion being A % and the second memory space with the proportion being (100%−A %), and the allocation parameter of the target memory space includes A % and B %=(100%−A %).

Optionally, in this embodiment, the fourth proportion may, but is not limited to, be obtained through division according to the proportions of the first memory space and the second memory space in the target memory space. For example, the proportion of the first memory space in the target memory space is A %, the proportion of the second memory space is B %=(100%−A %), and C % may, but is not limited to, be divided from the proportion A % of the first memory space as the fourth proportion. Alternatively, C % may, but is not limited to, be divided from the proportion (100%−A %) of the second memory space as the fourth proportion. Alternatively, C % may, but is not limited to, be divided from the proportion A % of the first memory space, then D % is divided from the proportion (100%−A %) of the second memory space, and C % and D % are used as the fourth proportion.

In an exemplary embodiment, the allocation parameter of the target memory space may, but is not limited to, be acquired by using the following manner: a first allocation proportion of the first memory space in the target memory space and a second allocation proportion of the second memory space in the target memory space are acquired, wherein the allocation parameter includes the first allocation proportion and the second allocation proportion. The target ratio and the fourth proportion may, but are not limited to, be determined by using the following manners: the first allocation proportion and the second allocation proportion are determined as the target ratio; and a fourth preset proportion is acquired as the fourth proportion.

Optionally, in this embodiment, the proportion of the first memory space in the target memory space may, but is not limited to, be determined as the first allocation proportion, the proportion of the second memory space in the target memory space is determined as the second allocation proportion, and the first allocation proportion and the second allocation proportion may, but are not limited to, be determined as the allocation parameters.

Optionally, in this embodiment, the fourth preset proportion may, but is not limited to, be predetermined, and the fourth preset proportion may, but is not limited to, be configured to determine the fourth proportion.

Optionally, in this embodiment, the fourth proportion may, but is not limited to, be determined according to the proportion of the first memory space in the target memory space, the proportion of the second memory space in the target memory space, and the fourth preset proportion. For example, the fourth preset proportion is 20%, the proportion of the first memory space in the target memory space is A %−10%, the proportion of the second memory space in the target memory space is 90%−A %, and the fourth proportion may be, but is not limited to, determined to be 20%.

In the technical solution provided in S204, the proportions of the first memory space and the second memory space in the target memory space may, but are not limited to, be determined as the allocation parameter of the target memory space, and the allocation parameter of the target memory space may, but is not limited to, be determined when the target memory space is allocated for the target application. For example, the target memory space allocated for the target application includes the first memory space of an A capacity and the second memory space of a B capacity, and the allocation parameter of the target memory space includes the proportion A/(A+B) of the first memory space in the target memory space and the proportion B/(A+B) of the second memory space in the target memory space.

Optionally, in this embodiment, the target memory space may, but is not limited to, be divided into N intervals through the target migration parameter, so as to indicate the proportion of the memory space in the target memory space that allows to migrate the memory data. The target migration parameter of the target memory space may, but is not limited to, be determined according to the proportions of the first memory space and the second memory space in the target memory space. For example, the proportion of the first memory space in the target memory space is A, the proportion of the second memory space in the target memory space is 100−A, and the target migration parameter is (A−10):20:(90−A). Alternatively, the proportion of the first memory space in the target memory space is A, the proportion of the second memory space in the target memory space is 100−A, and the target migration parameter is A:(100−A).

Optionally, in this embodiment, the first frequency threshold may, but is not limited to, be predetermined, and the first frequency threshold may, but is not limited to, be configured to select the memory space being used at a high frequency in the second memory space.

Optionally, in this embodiment, partial memory space being used at a high frequency in the second memory space may, but is not limited to, be determined as the third memory space. Since the operation efficiency of the target application for the first memory space is higher than the operation efficiency of the target application for the second memory space, partial memory space being used at a high frequency in the second memory space is migrated to the first memory space, causing the operation efficiency of the target application to improve.

In an exemplary embodiment, the third memory space may, but is not limited to, be selected from the second memory space according to the memory using parameter and the target migration parameter by using the following manners: one or more memory pages, of which a ratio to a plurality of memory pages is a first proportion, from the plurality of memory pages as a first memory page set according to using parameters from high to low, wherein the plurality of memory pages are memory pages in the target memory space that have stored data, the memory using parameter includes the memory pages and the using parameters, which have a correspondence relationship, each of the using parameters is configured to indicate a frequency of a corresponding memory page being used, and the target migration parameter includes the first proportion; and the one or more memory pages belonging to the second memory space are extracted from the first memory page set, to obtain the third memory space.

Optionally, in this embodiment, the using parameter may be, but is not limited to, the use frequency of each memory page in the target memory space of the target application. For example, the target memory space includes the plurality of memory pages, for each operation (which may include, but is not limited to, adding, deleting, finding, modifying, etc.) performed on the memory page within one or more time periods, the number of times for using the memory page adds 1, a sum of the number of times for using the memory page within the one or more time periods is obtained, and then the sum of the number of times for performing the operation is weighted according to a distance between the time period in which the operation is performed and the current time, so as to obtain the using parameter of each memory page.

Optionally, in this embodiment, the plurality of memory pages may, but are not limited to, be sorted according to the using parameter. For example, each memory page is sorted from high to low according to the using parameter. Alternatively, each memory page is sorted from low to high according to the using parameter.

Optionally, in this embodiment, the first proportion is configured to indicate the memory pages that is a certain proportion of the target memory page. The first proportion may, but is not limited to, be determined according to the target migration parameter. For example, the target migration parameter of the target memory space is A:(100−A), and A may, but is not limited to, be determined as the first proportion. Alternatively, the target migration parameter of the target memory space is (A−10):20:(90−A), and (A−10) may, but is not limited to, be determined as the first proportion.

Optionally, in this embodiment, the first memory page set is the memory pages that are used in the target memory page at the highest frequency and is the first proportion. For example, the first proportion is 20%, the target memory space includes 100 memory pages, according to the frequency of the memory page being used, the memory pages are sorted according to a sequence from the memory page being used at a high frequency to the memory page being used at a high frequency, and 20 memory pages being used at the highest frequency are selected from high to low as the first memory page set.

Optionally, in this embodiment, the memory pages belonging to the second memory space among the memory pages being used at the highest frequency may, but are not limited to, be determined as the third memory space. For example, the first memory page set includes 100 memory pages, 50 memory pages belonging to the second memory space are found from the first memory page set, and the 50 memory pages belonging to the second memory space in the first memory page set are determined as the third memory space.

In an exemplary embodiment, before one or more memory pages of which a ratio to a plurality of memory pages is a first proportion, from the plurality of memory pages are selected as a first memory page set according to using parameters from high to low, the first proportion may, but is not limited to, be determined by using the following manners: the allocation parameter of the target memory space is acquired; and the first proportion is determined according to the allocation parameter.

Optionally, in this embodiment, the allocation parameter of the target memory space may be, but is not limited to, proportions of the first memory space and the second memory space in the target memory space. For example: the target memory space includes the first memory space with the proportion being A % and the second memory space with the proportion being (100%−A %), and the allocation parameter of the target memory space includes A % and B %=(100%−A %).

Optionally, in this embodiment, the allocation parameter of the target memory space may, but is not limited to, be determined as the first proportion of the target memory space. For example, the allocation parameter of the target memory space includes A % and B %=(100%−A %), the memory pages may, but are not limited to, be sorted according to the using parameter, A % is the first proportion, and the first A % is selected as the first memory page set from high to low. Alternatively, for example, the allocation parameter of the target memory space includes A %−C %:20%:100%−C %−A %, the memory pages may, but are not limited to, be sorted according to the using parameter, A %−C % is the first proportion, and the first A %−C % is selected as the first memory page set from high to low.

In an exemplary embodiment, the allocation parameter of the target memory space may, but is not limited to, be acquired by using the following manner: a first allocation proportion of the first memory space in the target memory space is acquired, wherein the allocation parameter includes the first allocation proportion. The first proportion may, but is not limited to, be determined according to the allocation parameter by using the following manner: a difference value between the first allocation proportion and a first preset proportion is determined as the first proportion.

Optionally, in this embodiment, the proportion of the first memory space in the target memory space may, but is not limited to, be determined as the first allocation proportion.

Optionally, in this embodiment, the first preset proportion may, but is not limited to, be predetermined, and is configured to determine the first proportion from the first allocation proportion.

Optionally, in this embodiment, the first proportion may, but is not limited to, be determined according to the proportion of the first memory space in the target memory space and the first preset proportion. For example, the first preset proportion is 20%, the proportion of the first memory space in the target memory space is A %, and the first proportion is A %−20%.

In an exemplary embodiment, an example of screening the third memory space from the second memory space is provided. FIG. 7 is a schematic diagram of screening of a third memory space from a second memory space according to embodiments of the present disclosure. As shown in FIG. 7, for example, the first preset proportion is 20%, the third memory space may, but is not limited to, be determined through the following processes.

The first memory space: the second memory space in the allocation parameter of the target memory space is 60%:40%, the target migration parameter is determined to be 60%:40% according to the allocation parameter of the target memory space, and the target memory space is sorted from high to low according to the memory using parameter.

The first proportion is determined to be 60%−20%=40% according to the target migration parameter being 60%:40% and the first preset proportion being 20%, and the first 40% is determined as the first memory page set.

The memory pages belonging to the second memory space are acquired as the third memory space from the first memory page set.

In an exemplary embodiment, the third memory space may, but is not limited to, be selected from the second memory space according to the memory using parameter and the target migration parameter by using the following manners: a plurality of memory pages are divided into a first portion and a second portion according to using parameters from high to low, wherein a ratio of the first portion to the second portion is a target ratio, the plurality of memory pages are memory pages in the target memory space that have stored data, the memory using parameter includes the memory pages and the using parameters, which have a correspondence relationship, and each of the using parameters is configured to indicate a frequency of a corresponding memory page being used; one or more memory pages, of which a ratio to the first portion is a second proportion, in the first portion are removed according to the using parameters from low to high, to obtain a second memory page set, wherein the target migration parameter includes the target ratio and the second proportion; and one or more memory pages belonging to the second memory space are selected from the second memory page set, to obtain the third memory space.

Optionally, in this embodiment, each memory page in the target memory space may, but is not limited to, be divided according to the use frequency of each memory page in the target memory space, to obtain the first portion with a high use frequency and the second portion with a low use frequency.

Optionally, in this embodiment, the target ratio of the first portion to the second portion may, but is not limited to, be determined according to the proportions of the first memory space and the second memory space in the target memory space. For example: the proportion of the first memory space in the target memory space is A %, the proportion of the second memory space is B %=(100%−A %), the target memory space may, but is not limited to, be sorted from high to low according to the using parameters, the first A % is divided into the first portion, and the last B % is divided into the second portion.

Optionally, in this embodiment, the second proportion may, but is not limited to, be obtained by dividing a portion of memory spaces from the proportions of the first memory space and the second memory space in the target memory space.

Optionally, in this embodiment, the memory pages of the second proportion with the lowest using parameter may, but are not limited to, be removed from the first portion, so as to obtain the second memory page set. For example, the second proportion is 10%, the target memory space is arranged from high to low according to the using parameter, the first A % is divided into the first portion, the last B % is divided into the second portion, and then 10% is removed from the first portion from low to high, so as to obtain the second memory page set.

Optionally, in this embodiment, the memory pages belonging to the second memory space in the second memory page set may, but are not limited to, be determined as the third memory space.

In an exemplary embodiment, before the plurality of memory pages are divided into the first portion and the second portion according to the using parameters from high to low, the target ratio and the second proportion may, but are not limited to, be determined by using the following manners: the allocation parameter of the target memory space is acquired; and the target ratio and the second proportion are determined according to the allocation parameter.

Optionally, in this embodiment, the allocation parameter of the target memory space may be, but is not limited to, proportions of the first memory space and the second memory space in the target memory space. For example: the target memory space includes the first memory space with the proportion being A % and the second memory space with the proportion being (100%−A %), and the allocation parameter of the target memory space includes A % and B %=(100%−A %).

Optionally, in this embodiment, the second proportion may, but is not limited to, be obtained through division according to the proportions of the first memory space and the second memory space in the target memory space. For example, the proportion of the first memory space in the target memory space is A %, the proportion of the second memory space is B %=(100%−A %), and C % may, but is not limited to, be divided from the proportion A % of the first memory space as the second proportion. Alternatively, C % may, but is not limited to, be divided from the proportion (100%−A %) of the second memory space as the second proportion. Alternatively, C % may, but is not limited to, be divided from the proportion A % of the first memory space, then D % is divided from the proportion (100%−A %) of the second memory space, and C % and D % are used as the second proportion.

In an exemplary embodiment, the allocation parameter of the target memory space may, but is not limited to, be acquired by using the following manner: a first allocation proportion of the first memory space in the target memory space and a second allocation proportion of the second memory space in the target memory space are acquired, wherein the allocation parameter includes the first allocation proportion and the second allocation proportion. The target ratio and the second proportion may, but are not limited to, be determined by using the following manners: the first allocation proportion and the second allocation proportion are determined as the target ratio; and a second preset proportion is acquired as the second proportion.

Optionally, in this embodiment, the proportion of the first memory space in the target memory space may, but is not limited to, be determined as the first allocation proportion, the proportion of the second memory space in the target memory space is determined as the second allocation proportion, and the first allocation proportion and the second allocation proportion may, but are not limited to, be determined as the allocation parameters.

Optionally, in this embodiment, the second proportion may, but is not limited to, be determined according to the proportion of the first memory space in the target memory space, the proportion of the second memory space in the target memory space, and the second preset proportion. For example: the second preset proportion is 20%, the proportion of the first memory space in the target memory space is A %−10%, the proportion of the second memory space in the target memory space is 90%−A %, and the second proportion may be, but is not limited to, 20%.

In the technical solution provided in S206, the first memory data stored in the third memory space may, but is not limited to, be replicated to the first memory space, to realize the migration of the first memory data stored in the third memory space to the first memory space.

In an exemplary embodiment, the first memory data stored in the third memory space may, but is not limited to, be migrated to the first memory space by using the following manners: a reference remaining capacity of the first memory space is detected; when a data volume of the first memory data is greater than the reference remaining capacity, target memory data of which data volume is the reference remaining capacity is selected from all memory pages used in the first memory data; and the target memory data is migrated to the first memory space.

Optionally, in this embodiment, the reference remaining capacity may be, but is not limited to, a memory space that is not used in the first memory space, or a data volume that the first memory space can accommodate without affecting the use of the first memory space.

Optionally, in this embodiment, the first 90% of the first memory data may, but is not limited to, be determined as the target memory data, or the memory data with the highest memory using parameter in the first memory data may, but is not limited to, be determined as the target memory data.

In an exemplary embodiment, an example of performing memory data migration in the first memory space and the second memory space is provided. FIG. 8 is a schematic diagram of execution of memory data migration in a first memory space and a second memory space according to embodiments of the present disclosure. As shown in FIG. 8, for example, a memory data migration operation is performed in a Linux system, the first memory space is a local memory, and the second memory space is a CXL memory. In order to improve the usage efficiency of a memory of the Linux system, in the present disclosure, a “warm” memory is set and kept from being migrated, such that the number of times for performing memory migration on the memory page with the use frequency being in a middle position is reduced.

As shown in FIG. 8, the Linux system includes a Software Development Kit (SDK) and Hardware (HW). The local memory and the CXL memory are deployed in the HW. The SDK includes a Linux kernel module, a memory pooling module, a memory layering module, a memory migration module, a memory identification module, and an API module.

The Linux kernel module may, but is not limited to, be based on a Linux6.2 development driver and a CXL memory related interface. The memory identification module is included, and may, but is not limited to, identify a CXL memory capacity and an address through the Linux kernel module. For example, the Linux kernel module identifies the CXL memory as an RAM during the starting up of an operating system, identifies and modifies an attribute of the CXL memory as soft reserved, maps the local memory and the CXL memory into different groups (Normal, CxlMemory) in buddyinfo, reads a CXL memory distance, records the number of slots used by the CXL memory, calculates the number of bandwidths that may be provided by the CXL memory, and provides an API that modifies a NUMA node.

The memory pooling module is configured to allocate a memory for each application when the system starts. The memory pooling module may use, but is not limited to, a memory allocation mode that combines a tcmalloc allocator and a jemalloc allocator, for example, actively configured to allocate the local memory with a capacity being 1 GB and the CXL memory with a capacity being 1 GB for an application. The memory pooling module includes an application table that is configured to store the maximum usage of the local memory and the CXL memory for each application during use, and may allocate, but is not limited to, a space for the application according to the maximum usage stored in the application table.

The memory layering module may, but is not limited to, be configured to record the memory using parameter of the target memory space, and screen a memory space to be migrated according to the memory using parameter and the target migration parameter.

The memory migration module is configured to migrate the memory space to be migrated that is screened by the memory layering module.

“Hot” memory data (memory pages with a high frequency) in the CXL memory is stored in the local memory, and memory data migration may, but is not limited to, be performed in the first memory space and the second memory space through the following manners.

First, a remaining capacity a of the local memory in the memory pool (target memory space) is calculated, a portion of the “hot” memory data (third memory space) of the CXL memory with a size not exceed 90% of a is packed into a data block, and replicated to the local memory in a unified manner, a layering table for recording a memory allocation situation and BitMap for managing the memory are correspondingly converted and integrated, and a position corresponding to a “hot” memory in an original CXL memory that has been replicated is cleared to 0; and storage pauses when the amount of the local memory used reaches 90%, and then “cold” memory data (fourth memory space) of the local memory is replicated to the CXL memory.

First, a remaining capacity b of the CXL memory in the memory pool (target memory space) is calculated, a portion of the “cold” memory data of the local memory with a size not exceed 90% of b is packed into a data block, and replicated to the CXL memory in a unified manner, then a layering table for recording a memory allocation situation and BitMap for managing the memory are correspondingly converted and integrated, and a position corresponding to a “cold” memory in an original local memory that has been replicated is cleared to 0.

Storage pauses when the amount of the CXL memory used reaches 90%, and then the “hot” memory data of the CXL memory is continuously stored in the local memory, until the “hot” memory data of the CXL memory is entirely stored in the local memory, and the “cold” data of the local memory is entirely stored in the CXL memory.

During migration of the memory page, the memory pages that have been completed used may, but are not limited to, be preferably migrated, and then other memory pages are migrated. Migration granularity may, but is not limited to, be set for a recording situation of class_size (scale) of the memory page, and the memory page is migrated according to the migration granularity. For example, a “hot” memory page 1 in the CXL memory needs to be migrated to the local memory, Table 1 is a recording table for the scale of the memory page 1 according to the embodiments of the present disclosure. As shown in Table 1, the migration granularity of the memory page 1 is first set to 256 Byte, then a memory block that has been used is found according to an offset that is allocated in an offset migration page 1, and is migrated to the local memory, then the migration granularity is updated in sequence, and then other memory blocks that have been used are found according to the Offset that is allocated in the Page 1, and are migrated to the local memory, until the migration of the current memory page 1 is completed.

A memory is pre-allocated for an application by using the API, memory allocation and migration situations are enabled, disabled, and set, and statistical BitMap checks the usage of the local memory and the CXL memory.

TABLE 1

| Size | | Number (a number of page data | Offset |
|---|---|---|---|
| (migration granularity) | | blocks) | (offset) |
| 8 | Byte | 3 | 0 × 0000, |
| | | | 0 × 0007, |
| | | | 0 × 0015 |
| 32 | Byte | 2 | 0 × 0a00, |
| | | | 0 × 0a30 |
| 256 | Byte | 1 | 0 × 1b00 |

From the above descriptions about the implementation modes, those skilled in the art may clearly know that the method according to the foregoing embodiments may be implemented in a manner of combining software and a necessary universal hardware platform, and of course, may also be implemented through hardware, but the former is a preferred implementation mode under many circumstances. Based on such an understanding, the technical solutions of the present disclosure substantially or parts making contributions to the conventional art may be embodied in form of software product, and the computer software product is stored in a non-volatile computer-readable storage medium (for example, a ROM/RAM), a magnetic disk and an optical disk), including a plurality of instructions configured to enable a terminal device (which may be a mobile phone, a computer, a server, a network device, or the like) to execute the method in each embodiment of the present disclosure.

This embodiment further provides a memory data migration apparatus. The apparatus is configured to implement the above embodiments and optional implementations, and what has been described will not be described again. As used below, the term “module” may be a combination of software and/or hardware that implements a predetermined function. Although the apparatus described in the following embodiments is preferably implemented in software, but implementations in hardware, or a combination of software and hardware, are also possible and conceived.

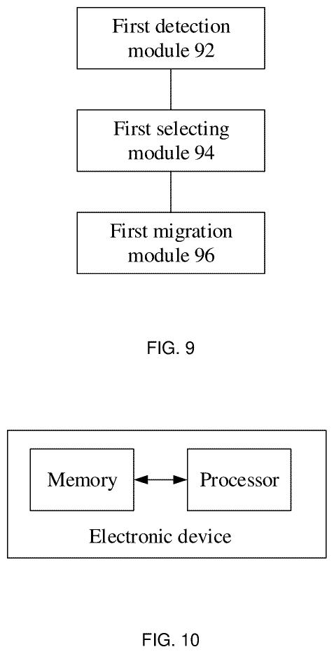

FIG. 9 is a structural block diagram of an apparatus of migrating memory data according to embodiments of the present disclosure. As shown in FIG. 9, the apparatus includes:
a first detection module 92 is configured to detect a memory using parameter of a target memory space, wherein the target memory space is a memory space that is allocated to a target application of which memory data is to be migrated, the target memory space includes a first memory space belonging to a first type and a second memory space belonging to a second type, the memory using parameter is configured to indicate a frequency distribution of the target memory space being used, and an operation efficiency of the target application for the first memory space is higher than an operation efficiency of the target application for the second memory space;
a first selection module 94 is configured to select a third memory space from the second memory space according to the memory using parameter and a target migration parameter, wherein the target migration parameter is determined according to an allocation parameter of the target memory space, the allocation parameter is configured to indicate proportions of the first memory space and the second memory space in the target memory space, the target migration parameter is configured to indicate a proportion of a memory space, in which memory data is allowed to be migrated, in the target memory space, and the third memory space is a memory space being used in the second memory space at a frequency higher than a first frequency threshold;
a first migration module 96 is configured to migrate first memory data stored in the third memory space to the first memory space.

Through the above apparatus, the target memory space used by the target application includes the first memory space and the second memory space. The memory space, which is the third memory space needs to be migrated, being used at a high frequency in the second memory space is screened from the target memory space according to the frequency distribution of the target memory space being used and the allocation parameter of the target memory space. Because the operation efficiency of the target application for the first memory space is higher than the operation efficiency of the target application for the second memory space, by migrating the first memory data stored in partial memory space with high usage efficiency in the second memory space to the first memory space, the operation efficiency of the target application to the memory data with high usage efficiency is improved, thereby improving the operation efficiency of the target application. Therefore, the problem of relatively low usage efficiency of a memory may be solved, thereby achieving the effect of improving the usage efficiency of the memory.

In an exemplary embodiment, the first selecting module includes:
a first selection unit is configured to select one or more memory pages, of which a ratio to a plurality of memory pages is a first proportion, from the plurality of memory pages as a first memory page set according to using parameters from high to low, wherein the plurality of memory pages are memory pages in the target memory space that have stored data, the memory using parameter includes the memory pages and the using parameters, which have a correspondence relationship, each of the using parameters is configured to indicate a frequency of a corresponding memory page being used, and the target migration parameter includes the first proportion;
a second selection unit is configured to select the one or more memory pages belonging to the second memory space from the first memory page set, to obtain the third memory space.

In an exemplary embodiment, the apparatus further includes:
a first acquisition module is configured to acquire the allocation parameter of the target memory space;
a first determination module is configured to determine the first proportion according to the allocation parameter.

In an exemplary embodiment, the first acquisition module includes:
a first acquisition unit is configured to acquire a first allocation proportion of the first memory space in the target memory space, wherein the allocation parameter includes the first allocation proportion.

In an exemplary embodiment, the first determination module includes:
a first determination unit is configured to determine a difference value between the first allocation proportion and a first preset proportion as the first proportion.

In an exemplary embodiment, the first selection module includes:
a first division unit is configured to divide a plurality of memory pages into a first portion and a second portion according to using parameters from high to low, wherein a ratio of the first portion to the second portion is a target ratio, the plurality of memory pages are memory pages in the target memory space that have stored data, the memory using parameter includes the memory pages and the using parameters, which have a correspondence relationship, and each of the using parameters is configured to indicate a frequency of a corresponding memory page being used.
a first removing unit is configured to remove one or more memory pages, of which a ratio to the first portion is a second proportion, in the first portion according to the using parameters from low to high, to obtain a second memory page set, wherein the target migration parameter includes the target ratio and the second proportion;
a third selection unit is configured to select one or more memory pages belonging to the second memory space from the second memory page set, to obtain the third memory space.

In an exemplary embodiment, the apparatus further includes:
a second acquisition module is configured to acquire the allocation parameter of the target memory space;
a second determination module is configured to determine the target ratio and the second proportion according to the allocation parameter.

In an exemplary embodiment, the second acquisition module includes:
a second acquisition unit is configured to acquire a first allocation proportion of the first memory space in the target memory space, and a second allocation proportion of the second memory space in the target memory space, where the allocation parameter includes the first allocation proportion and the second allocation proportion.

In an exemplary embodiment, the second determination module includes:
a second determination unit is configured to determine the first allocation proportion and the second allocation proportion as the target ratio; and acquiring a second preset proportion as the second proportion.

In an exemplary embodiment, the apparatus further includes:
a second selection module is configured to select a fourth memory space from the first memory space according to the memory using parameter and the target migration parameter, where the fourth memory space is a memory space being used in the first memory space at a frequency lower than a second frequency threshold;
a second migration module is configured to migrate second memory data stored in the fourth memory space to the second memory space.

In an exemplary embodiment, the second selection module includes:
a fourth selection unit is configured to select one or more memory pages, of which a ratio to a plurality of memory pages is a third proportion, in the plurality of memory pages as a third memory page set according to using parameters from low to high, wherein the plurality of memory pages are memory pages in the target memory space that have stored data, the memory using parameter includes the memory pages and the using parameters, which have a correspondence relationship, each of the using parameters is configured to indicate a frequency of a corresponding memory page being used, and the target migration parameter includes the third proportion;
a fifth selection unit is configured to select memory pages belonging to the first memory space from the third memory page set, to obtain the fourth memory space.

In an exemplary embodiment, the apparatus further includes:
a third acquisition module is configured to acquire the allocation parameter of the target memory space;
a third determination module is configured to determine the third proportion according to the allocation parameter.

In an exemplary embodiment, the third acquisition module includes:
a third acquisition unit is configured to acquire a second allocation proportion of the second memory space in the target memory space, where the allocation parameter includes the second allocation proportion.

In an exemplary embodiment, the third determination module includes:
a third determination unit is configured to determine a difference value between the second allocation proportion and a second preset proportion as the third proportion.

In an exemplary embodiment, the second selection module includes:
a second division unit is configured to divide a plurality of memory pages into a first portion and a second portion according to using parameters from high to low, wherein a ratio of the first portion to the second portion is a target ratio, the plurality of memory pages are memory pages in the target memory space that have stored data, the memory using parameter includes the memory pages and the using parameters, which have a correspondence relationship, and each of the using parameters is configured to indicate a frequency of a corresponding memory page being used;
a second removing unit is configured to remove one or more memory pages, of which a ratio to the second portion is meet a fourth proportion, in the second portion according to the using parameters from high to low, to obtain a fourth memory page set, wherein the target migration parameter includes the target ratio and the fourth proportion;
a sixth selection unit is configured to select one or more memory pages belonging to the first memory space from the fourth memory page set, to obtain the fourth memory space.

In an exemplary embodiment, the apparatus further includes:
a fourth acquisition module is configured to acquire the allocation parameter of the target memory space;
a fourth determination module is configured to determine the target ratio and the fourth proportion according to the allocation parameter.

In an exemplary embodiment, the fourth acquisition module includes:
a fourth acquisition unit is configured to acquire a first allocation proportion of the first memory space in the target memory space, and a second allocation proportion of the second memory space in the target memory space, wherein the allocation parameter includes the first allocation proportion and the second allocation proportion.

In an exemplary embodiment, the fourth determination module includes:
a fourth determination unit is configured to determine the first allocation proportion and the second allocation proportion as the target ratio; and acquire a fourth preset proportion as the fourth proportion.

In an exemplary embodiment, the first migration module includes:
a first detection unit is configured to detect a reference remaining capacity of the first memory space;
a selection unit is configured to: when a data volume of the first memory data is greater than the reference remaining capacity, select target memory data of which data volume is the reference remaining capacity from all memory pages used in the first memory data;
a migration unit is configured to migrate the target memory data to the first memory space.

In an exemplary embodiment, the first detection module includes:
a collection unit is configured to collect a use frequency of a target memory page in each time period of one or more time periods, to obtain one or more use frequencies, wherein the target memory page is each of a plurality of memory pages in the target memory space that have stored data;
a calculation unit is configured to calculate a using parameter corresponding to the target memory page according to the one or more using frequencies, to obtain a memory page (namely, the target memory page) and the using parameter, which having a correspondence relationship, as the memory using parameter.

In an exemplary embodiment, the calculation unit is further configured to: allocate a weight to the each time period according to a difference between the each time period and a current time, wherein the smaller the difference between the each time period and the current time is, the larger the weight corresponding to the each time period becomes; and calculate a weighted sum of the one or more use frequencies by using the weight to the each time period as the using parameter corresponding to the target memory page.

In an exemplary embodiment, the apparatus further includes:
a second detection module is configured to detect a usage rate of an initial memory space allocated for the target application;
an adjustment module is configured to adjust the initial memory space according to a relationship between the usage rate and a usage rate threshold, to obtain the target memory space.

In an exemplary embodiment, the adjustment module includes:
an allocation unit is configured to, when the usage rate is greater than or equal to a first usage rate threshold, allocate an additional memory space of a first capacity to the target application, to obtain the target memory space, where the target memory space includes the initial memory space and the additional memory space;
an releasing unit is configured to, when the usage rate is less than or equal to a second usage rate threshold, release a memory space of a second capacity from the initial memory space, to obtain the target memory space.

In an exemplary embodiment, the adjustment module includes:
a second detection unit is configured to detect a target number of processor cores used by the target application.
a first adjustment unit is configured to: when the target number is greater than or equal to a number threshold, adjust the initial memory space by using a first memory tool.
a second adjustment unit is configured to: when the target number is less than the number threshold, adjust the initial memory space by using a second memory tool, wherein an adjustment efficiency of the second memory tool to a memory space is lower than an adjustment efficiency of the first memory tool to the memory space, and an operating load of the second memory tool is less than an operating load of the first memory tool.

It is to be noted that, each of the above modules may be implemented by software or hardware. For the latter, it may be implemented in the following manners, but is not limited to the follow: the above modules are all located in a same processor; or the above modules are located in different processors in any combination.

An embodiment of the present disclosure further provides a non-volatile computer-readable storage medium. The non-volatile computer-readable storage medium stores a computer program. Steps in any one of the above method embodiments are executed when the computer program is configured to run.

In an exemplary embodiment, the non-volatile computer-readable storage medium may include, but is not limited to, a USB flash disk, a Read-Only Memory (ROM), a Random Access Memory (RAM), and various media that can store computer programs, such as a mobile hard disk, a magnetic disk, or an optical disk.

An embodiment of the present disclosure further provides an electronic device. FIG. 10 is a schematic diagram of an electronic device according to embodiments of the present disclosure. As shown in FIG. 10, the electronic device includes a memory and a processor. The memory is configured to store a computer program. The processor is configured to run the computer program to execute steps in any one of method embodiments described above.

In an exemplary embodiment, the electronic device may further include a transmission device and an input/output device. The transmission device is connected to the processor. The input/output device is connected to the processor.

For examples in this embodiment, refer to the examples described in the foregoing embodiments and the exemplary implementations, and this embodiment will not be repeated thereto.

It is apparent that those skilled in the art should understand that the above mentioned modules or steps of the present disclosure may be implemented by a general computing device, and may also be gathered together on a single computing device or distributed in network composed of multiple computing devices. The above mentioned modules or steps of the present disclosure may be implemented with program codes executable by the computing device, so that may be stored in a storage device for execution by the computing device, and in some cases, the steps shown or described may be performed in a different sequence than herein, or can be fabricated into individual integrated circuit modules respectively, or multiple modules or steps thereof are fabricated into a single integrated circuit module for implementation. In this way, the present disclosure is not limited to any specific combination of hardware and software.

The above are only the optional embodiments of the present disclosure and are not intended to limit the present disclosure. For those skilled in the art, the present disclosure may have various modifications and variations. Any modifications, equivalent replacements, improvements and the like made within the principle of the present disclosure shall fall within the scope of protection of the present disclosure.

1. A method of migrating memory data, comprising:
detecting a memory using parameter of a target memory space, wherein the target memory space is a memory space that is allocated to a target application of which memory data is to be migrated, the target memory space comprises a first memory space belonging to a first type and a second memory space belonging to a second type, the memory using parameter is configured to indicate a frequency distribution of the target memory space being used, and an operation efficiency of the target application for the first memory space is higher than an operation efficiency of the target application for the second memory space;
selecting a third memory space from the second memory space according to the memory using parameter and a target migration parameter, wherein the target migration parameter is determined according to an allocation parameter of the target memory space, the allocation parameter is configured to indicate proportions of the first memory space and the second memory space in the target memory space, the target migration parameter is configured to indicate a proportion of a memory space, in which memory data is allowed to be migrated, in the target memory space, and the third memory space is a memory space being used in the second memory space at a frequency higher than a first frequency threshold; and
migrating first memory data stored in the third memory space to the first memory space;
wherein after detecting the memory using parameter of the target memory space, the method further comprises: selecting a fourth memory space from the first memory space according to the memory using parameter and the target migration parameter, wherein the fourth memory space is a memory space being used in the first memory space at a frequency lower than a second frequency threshold; migrating second memory data stored in the fourth memory space to the second memory space.

2. The method according to claim 1, wherein the selecting the third memory space from the second memory space according to the memory using parameter and the target migration parameter comprises:
selecting one or more memory pages of which a ratio to a plurality of memory pages is a first proportion, from the plurality of memory pages as a first memory page set according to using parameters from high to low, wherein the plurality of memory pages are memory pages in the target memory space that have stored data, the memory using parameter comprises the memory pages and the using parameters, which have a correspondence relationship, each of the using parameters is configured to indicate a frequency of a corresponding memory page being used, and the target migration parameter comprises the first proportion; and
selecting the one or more memory pages belonging to the second memory space from the first memory page set, to obtain the third memory space.

3. The method according to claim 2, wherein before selecting one or more memory pages of which a ratio to a plurality of memory pages is a first proportion, from the plurality of memory pages as a first memory page set according to using parameters from high to low, the method further comprises:
acquiring the allocation parameter of the target memory space; and
determining the first proportion according to the allocation parameter.

4. The method according to claim 3, wherein
the acquiring the allocation parameter of the target memory space comprises: acquiring a first allocation proportion of the first memory space in the target memory space, wherein the allocation parameter comprises the first allocation proportion; and
the determining the first proportion according to the allocation parameter comprises: determining a difference value between the first allocation proportion and a first preset proportion as the first proportion.

5. The method according to claim 1, wherein the selecting the third memory space from the second memory space according to the memory using parameter and the target migration parameter comprises:
dividing a plurality of memory pages into a first portion and a second portion according to using parameters from high to low, wherein a ratio of the first portion to the second portion is a target ratio, the plurality of memory pages are memory pages in the target memory space that have stored data, the memory using parameter comprises the memory pages and the using parameters, which have a correspondence relationship, and each of the using parameters is configured to indicate a frequency of a corresponding memory page being used; and
removing one or more memory pages, of which a ratio to the first portion is a second proportion, in the first portion according to the using parameters from low to high, to obtain a second memory page set, wherein the target migration parameter comprises the target ratio and the second proportion; and
selecting one or more memory pages belonging to the second memory space from the second memory page set, to obtain the third memory space.

6. The method according to claim 5, wherein before dividing the plurality of memory pages into the first portion and the second portion according to the using parameters from high to low, the method further comprises:
acquiring the allocation parameter of the target memory space; and
determining the target ratio and the second proportion according to the allocation parameter.

7. The method according to claim 6, wherein
the acquiring the allocation parameter of the target memory space comprises: acquiring a first allocation proportion of the first memory space in the target memory space and a second allocation proportion of the second memory space in the target memory space, wherein the allocation parameter comprises the first allocation proportion and the second allocation proportion; and
the determining the target ratio and the second proportion according to the allocation parameter comprises: determining the first allocation proportion and the second allocation proportion as the target ratio; and acquiring a second preset proportion as the second proportion.

8. (canceled)

9. The method according to claim 81, wherein the selecting the fourth memory space from the first memory space according to the memory using parameter and the target migration parameter comprises:
selecting one or more memory pages, of which a ratio to a plurality of memory pages is a third proportion, in the plurality of memory pages as a third memory page set according to using parameters from low to high, wherein the plurality of memory pages are memory pages in the target memory space that have stored data, the memory using parameter comprises the memory pages and the using parameters, which have a correspondence relationship, each of the using parameters is configured to indicate a frequency of a corresponding memory page being used, and the target migration parameter comprises the third proportion; and
selecting memory pages belonging to the first memory space from the third memory page set, to obtain the fourth memory space.

10. The method according to claim 9, wherein before selecting one or more memory pages, of which a ratio to a plurality of memory pages is a third proportion, in the plurality of memory pages as a third memory page set according to using parameters from low to high, the method further comprises:
acquiring the allocation parameter of the target memory space; and
determining the third proportion according to the allocation parameter.

11. The method according to claim 10, wherein
the acquiring the allocation parameter of the target memory space comprises: acquiring a second allocation proportion of the second memory space in the target memory space, wherein the allocation parameter comprises the second allocation proportion; and
the determining the third proportion according to the allocation parameter comprises: determining a difference value between the second allocation proportion and a second preset proportion as the third proportion.

12. The method according to claim 81, wherein the selecting the fourth memory space from the first memory space according to the memory using parameter and the target migration parameter comprises:
dividing a plurality of memory pages into a first portion and a second portion according to using parameters from high to low, wherein a ratio of the first portion to the second portion is a target ratio, the plurality of memory pages are memory pages in the target memory space that have stored data, the memory using parameter comprises the memory pages and the using parameters, which have a correspondence relationship, and each of the using parameters is configured to indicate a frequency of a corresponding memory page being used; and
removing one or more memory pages, of which a ratio to the second portion is meet a fourth proportion, in the second portion according to the using parameters from high to low, to obtain a fourth memory page set, wherein the target migration parameter comprises the target ratio and the fourth proportion; and
selecting one or more memory pages belonging to the first memory space from the fourth memory page set, to obtain the fourth memory space.

13. The method according to claim 12, wherein before dividing the plurality of memory pages into the first portion and the second portion according to the using parameters from high to low, the method further comprises:
acquiring the allocation parameter of the target memory space; and
determining the target ratio and the fourth proportion according to the allocation parameter.

14. The method according to claim 13, wherein
the acquiring the allocation parameter of the target memory space comprises: acquiring a first allocation proportion of the first memory space in the target memory space and a second allocation proportion of the second memory space in the target memory space, wherein the allocation parameter comprises the first allocation proportion and the second allocation proportion; and
the determining the target ratio and the fourth proportion according to the allocation parameter comprises: determining the first allocation proportion and the second allocation proportion as the target ratio; and acquiring a fourth preset proportion as the fourth proportion.

15. The method according to claim 1, wherein the migrating first memory data stored in the third memory space to the first memory space comprises:
detecting a reference remaining capacity of the first memory space;
when a data volume of the first memory data is greater than the reference remaining capacity, selecting target memory data of which data volume is the reference remaining capacity from all memory pages used in the first memory data; and
migrating the target memory data to the first memory space.

16. The method according to claim 1, wherein the detecting the memory using parameter of the target memory space comprises:
collecting a use frequency of a target memory page in each time period of one or more time periods, to obtain one or more use frequencies, wherein the target memory page is each of a plurality of memory pages in the target memory space that have stored data; and
calculating a using parameter corresponding to the target memory page according to the one or more use frequencies, to obtain a memory page and the using parameter, which having a correspondence relationship, as the memory using parameter.

17. The method according to claim 16, wherein calculating the using parameter corresponding to the target memory page according to the one or more use frequencies comprises:
allocating a weight to the each time period according to a difference between the each time period and a current time, wherein the smaller the difference between the each time period and the current time is, the larger the weight corresponding to the each time period becomes; and
calculating a weighted sum of the one or more use frequencies by using the weight to the each time period as the using parameter corresponding to the target memory page.

18. The method according to claim 1, wherein before detecting the memory using parameter of the target memory space, the method further comprises:
detecting a usage rate of an initial memory space allocated for the target application; and
adjusting the initial memory space according to a relationship between the usage rate and a usage rate threshold, to obtain the target memory space.

19-20. (canceled)

21. An apparatus of migrating memory data, comprising:
a first detection module, configured to detect a memory using parameter of a target memory space, wherein the target memory space is a memory space that is allocated to a target application of which memory data is to be migrated, the target memory space comprises a first memory space belonging to a first type and a second memory space belonging to a second type, the memory using parameter is configured to indicate a frequency distribution of the target memory space being used, and an operation efficiency of the target application for the first memory space is higher than an operation efficiency of the target application for the second memory space;
a first selecting module, configured to select a third memory space from the second memory space according to the memory using parameter and a target migration parameter, wherein the target migration parameter is determined according to an allocation parameter of the target memory space, the allocation parameter is configured to indicate proportions of the first memory space and the second memory space in the target memory space, the target migration parameter is configured to indicate a proportion of a memory space, in which memory data is allowed to be migrated, in the target memory space, and the third memory space is a memory space being used in the second memory space at a frequency higher than a first frequency threshold; and
a first migration module, configured to migrate first memory data stored in the third memory space to the first memory space;
a second selection module, configured to, after the first detection module detects the memory using parameter of the target memory space, select a fourth memory space from the first memory space according to the memory using parameter and the target migration parameter, wherein the fourth memory space is a memory space being used in the first memory space at a frequency lower than a second frequency threshold; migrate second memory data stored in the fourth memory space to the second memory space.

22. A non-volatile computer-readable storage medium, having a computer program stored therein, wherein the computer program, when being executed by a processor, implements steps of the method according to claim 1.

23. An electronic device, comprising a memory, a processor, and a computer program that is stored in the memory and executable on the processor, wherein the processor, when executing the computer program, implements steps of the method according to claim 1.
